(19) United States
(12) Patent Application Publication
(10) Pub. No.: US 2008/0285406 A1
(43) Pub. Date: Nov. 20, 2008

(54) OPTICAL DISC APPARATUS AND OPTICAL DISC REPRODUCTION METHOD

(75) Inventors: Hiroyuki Moro, Tokyo (JP); Yasuhiro Kanishima, Tokyo (JP); Hideyuki Yamakawa, Tokyo (JP); Tatsuji Ashitani, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/116,880

(22) Filed: May 7, 2008

(30) Foreign Application Priority Data
May 14, 2007 (JP) 2007-128283

(51) Int. Cl. G11B 20/10

(52) U.S. Cl. 369/47.35

(57) ABSTRACT

Provided is an optical disc apparatus which reproduces with use of a PRML method an optical disc having data recorded in a plurality of code lengths, the optical disc apparatus including: an AD conversion unit adapted to convert a reproduction signal of the optical disc into a multi-value digital signal; a waveform equalization unit adapted to perform waveform equalization on the multi-value digital signal on the basis of a predetermined partial response to generate an equalized reproduction signal; a decoding unit adapted to generate decoded data corresponding to data recorded on the optical disc from the equalized reproduction signal; and a crest value extraction unit adapted to extract a crest value for each of the code lengths on the basis of the decoded data and a type of the predetermined partial response.

### CROSS-REFERENCE TO RELATED APPLICATIONS

This application claims the benefit of priority of Japanese Patent Application No. 2007-128283, filed May 14, 2007, the entire contents of which are incorporated herein by reference.

### BACKGROUND

1. Field

The present invention relates to an optical disc apparatus and an optical disc reproduction method. In particular, the invention relates to an optical disc apparatus and an optical disc reproduction method in which a reproduction signal of an optical disc is sampled as multi-value data to decode record data.

2. Description of the Related Art

In a high density recording type optical disc, for example, HD DVD, or the like, a reproduction method referred to as PRML (Partial Response Maximum Likelihood) signal processing method is used in many cases.

The PRML signal processing method is a signal processing method in which a narrowband Partial Response characteristic (PR) allowing a deliberate waveform interference and a Maximum Likelihood (ML) are combined as disclosed, for example, in JP-A 2005-93033, or the like. Along with a development of higher density recording, noise components are increased and an S/N of a reproduction signal is decreased. However, even in such a low S/N environment, with use of the PRML signal processing method, it is possible to significantly reduce erroneous detections as compared with a binary slice method in the past.

In the PRML signal processing method, an analog reproduction signal is sampled as multi-value data, and amplitude information of the reproduction signal is actively utilized for data decoding. This point is largely different from the conventional binary slice method which is based on a threshold.

As described above, in the PRML signal processing method, the amplitude information of the reproduction signal is used for the data decoding, the quality of the amplitude information is extremely important.

On the other hand, in a case of a recording type optical disc, the quality of the amplification information is affected by recording parameters such as a laser power at the time of recording (recording power) and a recording pulse waveform. This influence varies depending on a characteristic of an optical disc apparatus and also on a characteristic of an optical disc itself. For this reason, many optical disc apparatuses adopt such a procedure that test write of test data is performed in a particular area of the optical disc, and this test data is reproduced and evaluated to determine recording parameters optimum for an optical disc currently inserted therein.

Various evaluation indices for the reproduction signal of the test data are proposed. For example, an evaluation index regarding a vertical asymmetry of the reproduction signal includes an evaluation index of so-called asymmetry value β. In many of recording type CDs and DVDs, a recording power adjustment is performed so that the above-mentioned asymmetry value β is set close to zero (including an equivalent recording power adjustment based on a pulse width adjustment), which is referred to as OPC (Optimum Power Control).

Although the OPC includes various methods, in general, the following method is employed.

First, by using a DC level of a reproduction waveform as a reference, peak detection and bottom detection are carried out to obtain a peak value VH and a bottom value VL. Next, from the peak value VH and the bottom value VL, the asymmetry value β (β=(VH+VL)/(VH−VL)) representing the reproduction waveform symmetry is calculated. Then, the recording power is calculated so that the asymmetry value β becomes zero.

However, the conventionally used asymmetry value β is an index representing the symmetry of an average DC level for all code lengths (in a case of a CD or a conventional type DVD, code lengths of 3T to 11T), and therefore the asymmetry of each individual code length is not necessarily set as zero. For example, even when the asymmetry of the code length 3T is shifted to the positive side and the asymmetry of the code length 4T is shifted to the negative side, the average asymmetry value β may be set as zero in some cases.

On the other hand, in the high density recording type optical disc such as HD DVD, an influence of the asymmetry with respect to the quality of the reproduction signal is larger as compared with the conventional CD or DVD. For this reason, a need is emerging for adjusting the asymmetry in a finer manner as compared with the conventional case. In other words, not only the average asymmetry of all the code lengths is intended to be set as zero as in the conventional case, but also it is necessary to employ an adjustment method for setting the asymmetry of each individual code length close to zero.

Incidentally, in the case of calculating the asymmetry for each code length, it is necessary to obtain and calculate a crest value for each code length (for example, a peak value in the case of a mark and a bottom value in the case of a space). In general, random data is used as the test data. Thus, in the reproduction signal, marks and spaces of various code lengths, for example, 2T to 11T, are randomly mixed.

Therefore, in the case of calculating the asymmetry for each code length, it is necessary to identify a particular code length from a stream of the reproduction signal and accurately extract a crest value thereof. However, no technology has been developed for executing such a processing substantially in real time at a high speed and also efficiently.

### SUMMARY OF THE INVENTION

Accordingly, the present invention has been made in view of the above-mentioned circumstances, and it is an object of the present invention to provide an optical disc apparatus and an optical disc reproduction method in which it is possible to extract a crest value of each code length from a reproduction signal having a plurality of mixed code lengths at a high speed and also accurately.

In order to solve the above-mentioned problem, according to an aspect of the present invention, there is provided an optical disc apparatus which reproduces, with use of a PRML method, an optical disc having data recorded in a plurality of code lengths, the optical disc apparatus including: an AD conversion unit adapted to convert a reproduction signal of the optical disc into a multi-value digital signal; a waveform equalization unit adapted to perform waveform equalization on the multi-value digital signal on the basis of a predetermined partial response to generate an equalized reproduction signal; a decoding unit adapted to generate decoded data corresponding to data recorded on the optical disc from the equalized reproduction signal; and a crest value extraction unit adapted to extract a crest value for each of the code lengths on the basis of the decoded data and a type of the predetermined partial response.

In addition, in order to solve the above-mentioned problem, according to an aspect of the present invention, there is provided an optical disc reproduction method of reproducing with use of a PRML method an optical disc having data recorded in a plurality of code lengths, the method including the steps of: (a) converting a reproduction signal of the optical disc into a multi-value digital signal; (b) performing waveform equalization on the multi-value digital signal on the basis of a predetermined partial response to generate an equalized reproduction signal; (c) generating decoded data corresponding to data recorded on the optical disc from the equalized reproduction signal; and (d) extracting a crest value for each of the code lengths on the basis of the decoded data and a type of the predetermined partial response.

In the optical disc apparatus and the optical disc reproduction method according to the aspect of the present invention, it is possible to extract the crest value of each code length from the reproduction signal having a plurality of mixed code lengths at a high speed and also accurately.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 illustrates a configuration example of an optical disc apparatus according to an embodiment of the present invention;

FIG. 2 is an explanatory diagram of a method of calculating an asymmetry value for each code length by using a crest value for each code length;

FIGS. 3A to 3H illustrate record data of various code lengths and ideal equalized reproduction signals in a PR (12221) class corresponding to these code lengths;

FIGS. 4A to 4H illustrate record data of various code lengths and ideal equalized reproduction signals in a PR (1221) class corresponding to these code lengths;

FIGS. 5A to 5H illustrate record data of various code lengths and ideal equalized reproduction signals in a PR (121) class corresponding to these code lengths; and

FIG. 6 illustrates a configuration example of a crest value detection unit according to the embodiment of the present invention.

### DETAILED DESCRIPTION

Embodiments of an optical disc apparatus and an optical disc reproduction method according to the present invention will be described with reference to the accompanying drawings.

### (1) Configuration and Overall Operation of Optical Disc Apparatus

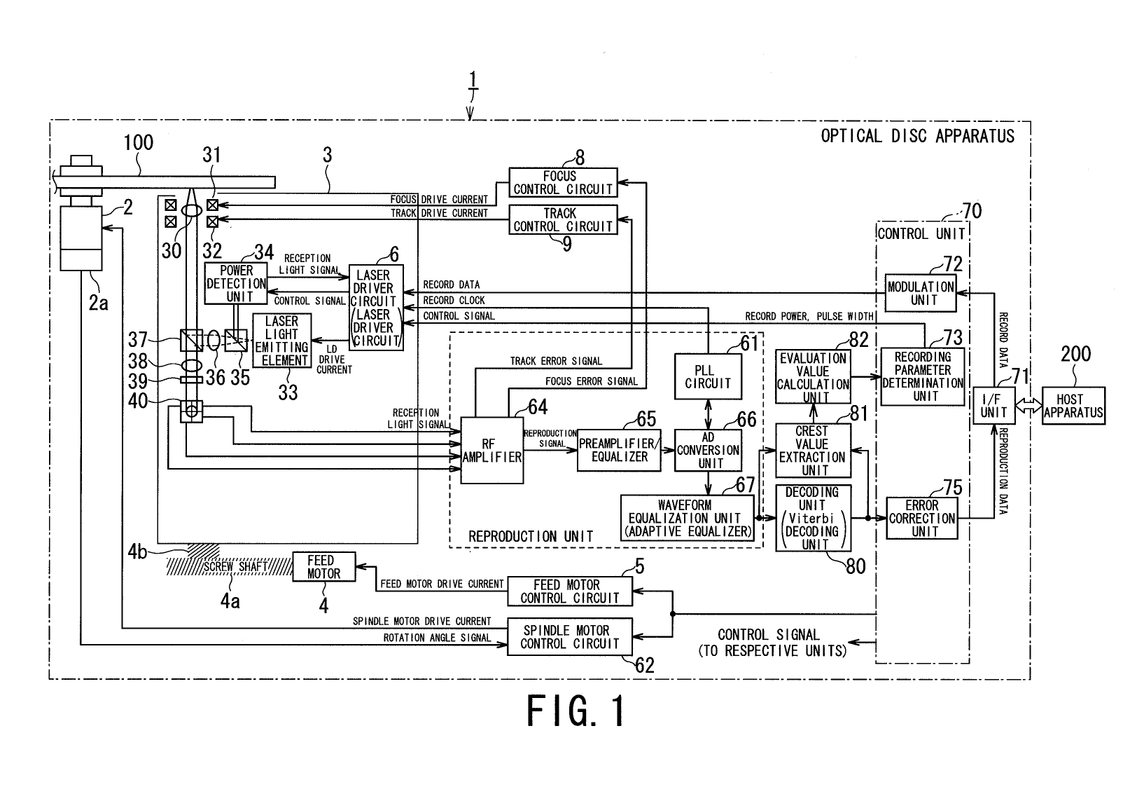

FIG. 1 illustrates a configuration example of an optical disc apparatus 1 according to an embodiment of the present invention.

The optical disc apparatus 1 is adapted to perform recording and reproduction of information with respect to an optical disc 100 such as HD DVD. On the optical disc 100, a channel is carved spirally. A concave part of the channel is called “groove” and a convex part thereof is called “land”. One circle of the groove or the land is called “track”. User data is recorded on the optical disc 100 along this track (only the groove, or the groove and the land) by forming marks and spaces corresponding to code lengths of data through irradiation with intensity-modulated laser light.

The data reproduction is performed by detecting changes in reflected light intensity caused by the record marks on the track through irradiation along the track with laser light having a read power which is weaker than the power during the recording. Deletion of the recorded data is performed by crystallizing the recording layer with irradiation along the track of laser light having an erase power which is stronger than the read power.

The optical disc 100 is rotated and driven by the spindle motor 2. A rotation angle signal is output from a rotary encoder 2a provided to the spindle motor 2. When the spindle motor 2 makes one revolution, the rotation angle signal generates five pulses, for example. From this rotation angle signal, it is possible to determine the rotation angle and the number of revolutions of the spindle motor 2. A spindle motor control circuit 62 performs a rotation drive control of the spindle motor 2 on the basis of these pieces of information.

Recording and reproduction of the information with respect to the optical disc 100 is performed by an optical pickup 3. The optical pickup 3 is connected to a feed motor 4 via a gear 4b and a screw shaft 4a, and the feed motor 4 is controlled by a feed motor control circuit 5. As the feed motor 4 is rotated by a feed motor drive current supplied from the feed motor control circuit 5, the optical pickup 3 is moved in a radius direction of the optical disc 100.

In the optical pickup 3, an objective lens 30 is provided while being supported by a wire or a leaf spring not shown in the drawing. The objective lens 30 is allowed to move in a focusing direction (an optical axis direction of the lens) by way of drive of a drive coil 31. Also, the objective lens 30 is allowed to move in a tracking direction (a direction orthogonal to the optical axis direction of the lens) by way of drive of a drive coil 32.

A laser driver circuit (recording unit) 6 supplies a write drive current to a laser diode (laser light emitting element) 33 on the basis of record data modulated through an ETM (Eight to Twelve Modulation) method or the like in a modulation unit 72. The modulation unit 72 is supplied with record data from a host apparatus 200 such as a personal computer via an I/F unit 71.

On the other hand, the laser driver circuit 6 supplies a read drive current which is smaller than the write drive current to the laser light emitting element 33 during information reading.

A power detection unit 34 configured of a photo diode, etc., (which may be referred to as front monitor (FM) in some cases) is adapted to divide a part of the laser light generated by the laser light emitting element 33 with use of the half mirror 35 at a given ratio and detect a signal in proportion to the light quantity, that is, the light emission power, as a reception light signal. The detected reception light signal is supplied to the laser driver circuit 6. The laser driver circuit 6 controls the laser light emitting element 33 on the basis of the reception light signal from the power detection unit 34 so that light emission is performed at a recording power, a recording pulse width, a reproduction power, and a deletion power which are determined or set by a recording parameter determination unit 73 of a control unit 70 or the like.

The laser light emitting element 33 emits laser light in accordance with the drive current supplied from the laser driver circuit 6. The optical disc 100 is irradiated with the laser light emitted from the laser diode 33 via a collimator lens 36, a half prism 37, and the objective lens 30.

On the other hand, a reflection light from the optical disc 100 is guided to a light detecting element 40 via the objective lens 30, the half prism 37, a collecting lens 38, and a cylindrical lens 39.

The light detecting element 40 is composed, for example, of four-partitioning light detection cells. Detection signals of these light detection cells are output to an RF amplifier 64 of a reproduction unit 60. The RF amplifier 64 processes the detection signals from the light detection cells to generate a focus error signal FE representing an error from the just focus, a tracking error signal TE representing an error between the beam spot center of the laser light and the center of the track, and a regeneration signal RF that is a full addition signal of the light detection cell signals.

The focus error signal FE is supplied to a focus control circuit 8. The focus control circuit 8 generates a focus drive signal in accordance with the focus error signal FE. The thus generated focus drive signal is supplied to the drive coil 31. With this configuration, a focus servo is performed so that the laser light regularly has the just focus on a recording film prepared on the optical disc 100.

On the other hand, the tracking error signal TE is supplied to a track control circuit 9. The track control circuit 9 generates a track drive signal in accordance with the tracking error signal TE. The track drive signal output from the track control circuit 9 is supplied to the drive coil 32 in the tracking direction. With this configuration, a tracking servo is performed so that the laser light regularly traces the track formed on the optical disc 100.

As the focus servo and the tracking servo described above are performed, the focal point of the laser light is allowed to follow the track on the optical disc recording surface with a satisfactory accuracy. As a result, the full addition signal RF of the output signals from the respective light detection cells of the light detecting element 40 reflects the changes in the reflection light from the marks and the spaces formed on the track formed on the optical disc 100 corresponding to the recording information, and it is therefore possible to obtain the reproduction signal with a satisfactory quality.

This reproduction signal (the full addition signal RF) is input to a preamplifier/equalizer 65 and amplified at an appropriate amplification therein to be subjected to a waveform shaping in an analog manner. An output from the preamplifier/equalizer 65 is sampled in an AD conversion unit 66 with use of a reproduction clock signal from a PLL circuit 61 to be converted into multi-value digital data.

The digitalized reproduction signal is input to a waveform equalization unit (adaptive equalizer) 67, and a waveform equalization processing in accordance with a type of a predetermined partial response (class) is carried out. The waveform equalization unit 67 is configured, for example, of an adaptive transversal filter. The waveform equalization unit 67 carries out the waveform equalization by generating reference data having an ideal partial response with respect to decoded data which is decoded in a decoding unit 80 in a later stage and adapting a weighting factor of the transversal filter so that en error between this reference data and the input data becomes zero.

The equalized reproduction signal which is the output of the waveform equalization unit 67 is input to the decoding unit 80. In the decoding unit 80, for example, the record data is decoded through a Viterbi decoding processing on the basis of a maximum likelihood from a series of the input equalized reproduction signal to obtain the decoded data.

The decoded data is input to an error correction unit 75. In the error correction unit 75, an error correction processing is carried out, and thereafter, the data is output to the host apparatus via the I/F unit 71.

On the other hand, the equalized reproduction signal which is the output of the waveform equalization unit 67 and the decoded data which is the output of the decoding unit 80 are input to a crest value extraction unit 81. In the crest value extraction unit 81, a crest value (peak value and bottom value) for each code length is extracted from the equalized reproduction signal. A detailed configuration and operation of the crest value extraction unit 81 will be described below.

The crest value extracted in the crest value extraction unit 81 is input to an evaluation value calculation unit 82. In the evaluation value calculation unit 82, an evaluation value for determining optimum recording parameters such as an optimum recording power and an optimum recording pulse width are calculated. An example of the evaluation value includes the asymmetry value for each code length.

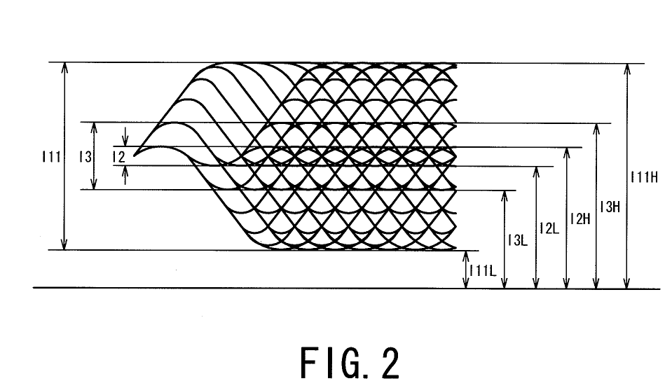

FIG. 2 is an explanatory diagram of a concept of the asymmetry. In HD DVD, user data is recorded on the basis of marks and spaced having lengths at code lengths from 2T to 11T (T denotes a unit length of the code length, and FIG. 2 is a diagram in which reproductions signals from these respective code lengths are overlapped one another.

In FIG. 2, I11H and I11L respectively represent crest values of a mark and a space at a code length 11T, I3H and I3L respectively represent crest values of a mark and a space at a code length 3T, and 12H and 12L respectively represent crest values of a mark and a space at a code length 2T. At this time, the asymmetry value A_{2T} at the code length 2T and the asymmetry value A_{3T} at the code length 3T are respectively defined by the following equations.

A_{2T}=((I11H+I11L)/2−(I2H+I2L)/2)/(I11H−I11L) (Equation 1)

A_{3T}=((I11H+I11L)/2−(I3H+I3L)/2)/(I11H−I11L) (Equation 2)

In addition, the asymmetry value A_{nT} at the code length nT is defined by the following expression.

A_{nT}=((I11H+I11L)/2−(InH+InL)/2)/(I11H−I11L) (Equation 3)

As is understood from these definitional equations, the asymmetry value at the code length nT is an index representing a coincidence between the center value of the mark and the space at 11T which is the maximum code length and the center value of the mark and the space at each code length nT. In the ideal reproduction signal waveform in which the vertical symmetry is completely ensured, the asymmetry values for the respective code lengths are all zero.

In actuality, the asymmetry value does not become zero due to fluctuations in the optical disc itself, the optical disc apparatus which carries out recording and reproduction of the optical disc, and the like. In view of the above, by adjusting the recording parameters such as the optimum recording power and the optimum recording pulse width, a processing for putting the asymmetry value close to zero is performed. Such a processing is referred to as OPC (Optimum Power Control).

In order to perform the OPC with a satisfactory accuracy, it is necessary to correctly calculate the asymmetry value. In this aspect, it is important to extract the exact crest value. In addition, in order to perform the OPC in a short period of time, it is also necessary to extract the crest value in a short period of time.

### (2) Configuration and Operation of Crest Value Extraction Unit

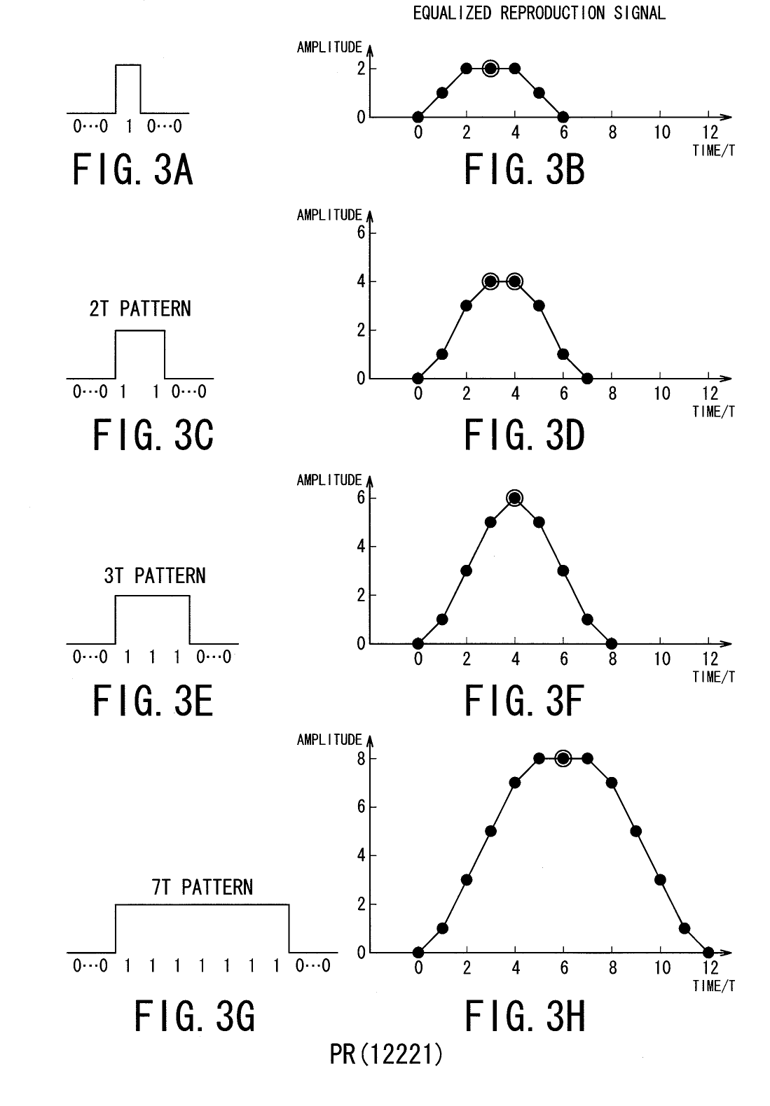

FIGS. 3A to 3H, FIGS. 4A to 4H, and FIGS. 5A to 5H are explanatory diagrams for describing an operation principle of the crest value extraction unit 81 according to the embodiment of the present invention. Among the drawings, FIGS. 3A to 3H correspond to a class (type) of the partial response referred to as PR (12221). FIGS. 3A, 3C, 3E, and 3G illustrate record data having different code lengths, and FIGS. 3B, 3D, 3F, and 3H illustrate ideal equalized reproduction signal waveforms (partial response waveforms) corresponding to the respective code lengths.

For example, FIG. 3A illustrates a unit pulse at the code length 1T, and FIG. 3B illustrates an equalized reproduction signal corresponding to the unit pulse. The partial response is a response allowing an inter-symbol interference. As is understood from the FIG. 3B, such a state is established that the partial response is spread at five positions except the zero amplitude with respect to the code length 1T. It should be noted that numerals in brackets of the PR (12221) denote an amplitude series of the response signal with respect to the unit pulse. The length of the response with respect to the unit pulse is determined on the basis of the class of the partial response (which is referred to as response length). In the case of PR (12221), the response length is 5.

FIG. 3C illustrates record data at the code length 2T, and FIG. 3D illustrates the ideal equalized reproduction signal therefor. Similarly, FIG. 3E illustrates record data at the code length 3T and FIG. 3F illustrates the ideal equalized reproduction signal therefor. FIG. 3G illustrates record data at the code length 7T and FIG. 3H illustrates the ideal equalized reproduction signal therefor.

As is understood from the respective drawings of FIGS. 3A to 3H, in a case where the crest value is extracted from the equalized reproduction signal, the amplitude value at the center of the recording data at the respective code lengths may be extracted.

This record data can be obtained as the decoded data from the decoding unit 80. That is, as the code length is detected from the decoded data and a position at the center thereof is identified, it is possible to obtain the crest values with respect to the respective code lengths. To be more specific, switching points (edges) between “0” or “1” of the decoded data are detected, the center between the edges is set as the center of the respective code lengths, and the amplitude value of the equalized reproduction signal at the sampling point may be extracted and set as the crest value.

Incidentally, as represented by double circles of the equalized reproduction signals in FIGS. 3B, 3D, 3F, and 3H, with regard to the sampling point at the center, there are a case where the position of the sampling point is set at one point and a case where the position of the sampling point straddles over two points. In the case of the PR (12221) class illustrated in FIGS. 3A to 3H, when the code length is an odd number, the sampling point at the center is set at one point, and when the code length is an even number, the sampling point at the center straddles over two points.

According to this embodiment, in a case where the sampling point at the center is set at one point, the equalized reproduction signal at the sampling point is extracted as it is and set as the crest value. In a case where the sampling point at the center straddles over two points, an average value of the two equalized reproduction signal at the two sampling points is set as the crest value.

It should be noted that whether the sampling point at the center is set at one point or straddles over two points varies depending on, in addition to the even number or the odd number of the code length, the class of the partial response, to be more specific, whether the response length of the partial response is an even number or an odd number.

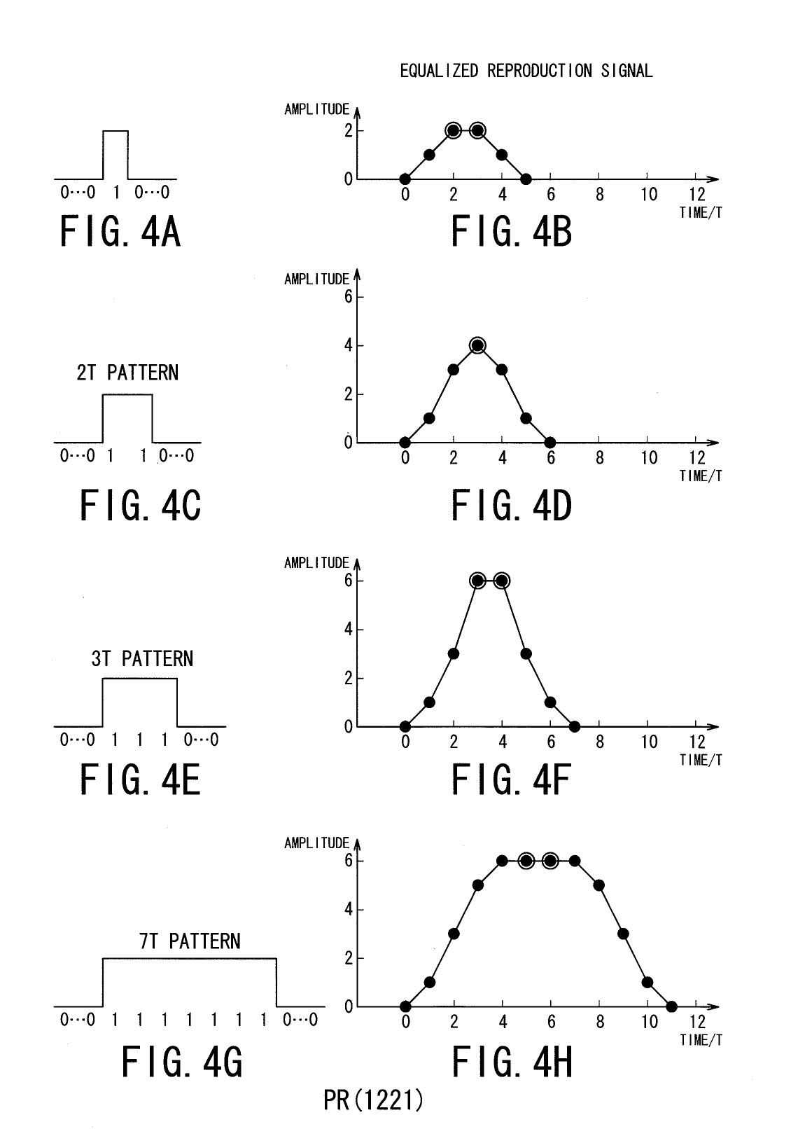

FIGS. 3A to 3H illustrate equalized reproduction signals of PR (12221) in which the response length is an odd number “5”. In contrast to this, FIGS. 4A to 4H illustrate equalized reproduction signals of PR (1221) in which the response length is an even number “4”. As is understood from the FIGS. 4A to 4H, in the PR (1221), when the code length is an odd number, the sampling point at the center straddles over two points (FIGS. 4B, 4F, and 4H), and when the code length is an even number, the sampling point at the center is set at one point (FIG. 4D).

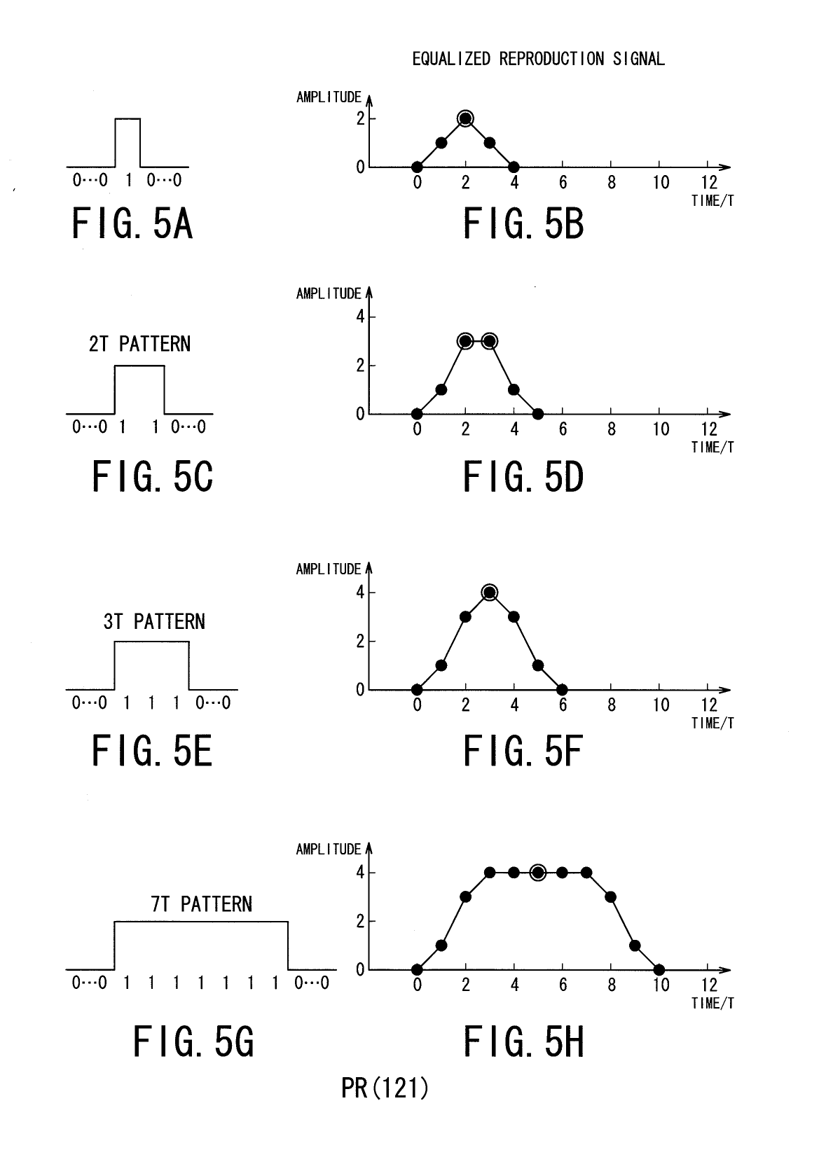

On the other hand, FIGS. 5A to 5H illustrate equalized reproduction signals of PR (121) in which the response length is an odd number “3”. As is understood from FIGS. 5A to 5H, in the PR (121), when the code length is an odd number, the sampling point at the center is set at one point (FIGS. 5B, 5F, and 5H), and when the code length is an even number, the sampling point at the center straddles over two points (FIG. 5D).

As is understood from the above-mentioned exemplary representations, such a rule is established that in a case where the response length of the partial response is an odd number (in the case of PR (12221), PR (121), or the like), when the code length is an odd number, the sampling point at the center is set at one point, and when the code length is an even number, the sampling point at the center straddles over two points.

On the other hand, such a rule is established that in a case where the response length of the partial response is an even number (in the case of PR (1221) or the like), when the code length is an odd number, the sampling point at the center straddles over two points, and when the code length is an even number, the sampling point at the center is set at one point.

According to this embodiment, by utilizing this rule, a processing is switched by determining whether the equalized reproduction signal at the one point at the center of the code length is set as the crest value or the average value of the equalized reproduction signals at the two points at the center is set as the crest value.

The processing of extracting the crest value on the basis of the above-mentioned operation principle can be realised by using software, but it is more advantageous to adopt a configuration by using hardware in terms of processing speed.

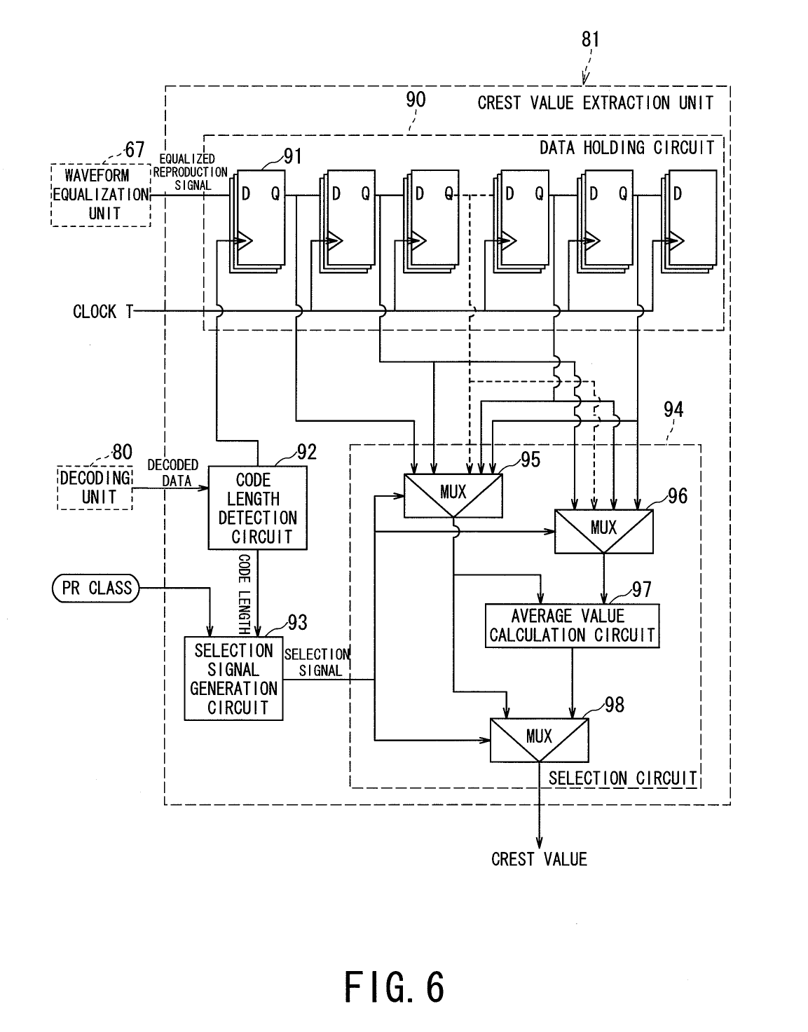

FIG. 6 illustrates a configuration example of the crest value extraction unit 81 configured by using hardware on the basis of the above-mentioned operation principle.

The crest value extraction unit 81 is configured by including a data holding circuit 90 provided with a plurality of registers 91, a code length detection circuit 92, a selection signal generation circuit 93, and a selection circuit 94. Also, the selection circuit 94 is configured by including three multiplexers 95, 96, and 98 and an average value calculation circuit 97.

The data holding circuit 90 is a circuit for holding the equalized reproduction signals output from the waveform equalization unit 67 while the equalized reproduction signals are sequentially delayed by a clock with the base unit T of the code length. The number of delay stages may be set as the number of the maximum code length.

The code length detection circuit 92 is a circuit for detecting the edges of the decoded data output from the decoding unit 80 to detect the length of the code length on the basis of a distance between the edges.

The selection signal generation circuit 93 is adapted to generate a selection signal used by the three multiplexers 95, 96, and 98, on the basis of the type of the partial response class and the code length.

In a case where on the basis of the code length and the response length of the partial response class, it is determined that the sampling point at the center is set at one point, a signal selecting the one point is output to the multiplexer 95.

Then, a selection signal selecting the output of the multiplexer 95 is output to the multiplexer 98. As a result, the equalized reproduction signal at the one point at the center of the code length is output as the crest value.

On the other hand, on the basis of the code length and the response length of the partial response class, it is determined that the sampling point at the center straddles over two points, a signal selecting one point is output to the multiplexer 95 and also a signal selecting the other one point is output to the multiplexer 96. As a result, an average value between the two signals is calculated in the average value calculation circuit 97. Also, a signal selecting the output of the average value calculation circuit 97 is output to the multiplexer 98. As a result, the average value between the equalized reproduction signals at the two points at the center of the code length is output as the crest value.

As described above, according to the optical disc apparatus and the optical disc reproduction method of this embodiment, it is possible to extract the crest value of each code length from the reproduction signal having a plurality of mixed code lengths at a high speed and also accurately, and as a result, it is possible to obtain the evaluation values such as the asymmetry value with a high accuracy and also at a high speed.

It should be noted that the present invention is not explicitly limited to the above-mentioned embodiments, and the present invention can be embodied in the implementing stage by modifying the components without departing from the scope of the invention. Also, various embodiments of the invention can be formed by appropriately combining the disclosed components of the above-mentioned embodiments. For example, some of the components may be deleted from all of the disclosed components according to the embodiments. Furthermore, components from different embodiments may be appropriately combined.

What is claimed is:

1. An optical disc apparatus configured to reproduce, with the use of a Partial Response Maximum Likelihood (PRML) method, data recorded on an optical disc using a plurality of code lengths, the optical disc apparatus comprising:
an analog-to-digital (AD) conversion unit configured to convert a reproduction signal of the optical disc into a multi-value digital signal;
a waveform equalization unit configured to perform waveform equalization on the multi-value digital signal on the basis of a predetermined partial response to generate an equalized reproduction signal;
a decoding unit configured to generate decoded data corresponding to data recorded on the optical disc from the equalized reproduction signal; and
a crest value extraction unit configured to extract a crest value for each of the code lengths on the basis of the decoded data and a type of the predetermined partial response.

2. The optical disc apparatus of claim 1, wherein the crest value extraction unit is configured to identify a code length from the decoded data and to extract an amplitude value of the equalized reproduction signal in a sampling point corresponding to a center of the identified code length as a crest value of the code length.

3. The optical disc apparatus of claim 2, wherein the crest value extraction unit is configured to determine whether the number of the sampling points corresponding to the center is 1 or 2 on the basis of the identified code length and the type of the predetermined partial response, and in the case of two sampling points, to extract an average value of two amplitude values of the equalized reproduction signal corresponding to the two sampling points as the crest value of the code length.

4. The optical disc apparatus of claim 3, wherein:
the crest value extraction unit is configured to determine that the number of the sampling points corresponding to the center is one in a case where the identified code length is an even number and also the response length of the predetermined partial response is an even number, or, in a case where the identified code length is an odd number and also the response length of the predetermined partial response is an odd number; and
the crest value extraction unit is configured to determine that the number of the sampling points corresponding to the center is two in a case where the identified code length is an odd number while the response length of the predetermined partial response is an even number, or, in a case where the identified code length is an even number while the response length of the predetermined partial response is an odd number.

5. The optical disc apparatus of claim 1, wherein the crest value extraction unit comprises:
a data holding circuit configured to delay-hold the equalized reproduction signal at a clock of a unit length of the code length;
a code length detection circuit configured to detect a data change point of the decoded data to detect the code length;
a selection signal generation circuit configured to determine the response length of the partial response from the type of the partial response and to generate a selection signal from the determined response length and the code length detected in the code length detection circuit; and
a selection circuit configured to select the amplitude value of the equalized reproduction signal at the sampling point corresponding to the center of the detected code length on the basis of the selection signal.

6. The optical disc apparatus of claim 5, wherein selection circuit comprises an average value calculation circuit configured to average two amplitude values of the equalized reproduction signal in the case of the two sampling points.

7. An optical disc data reproduction method of reproducing data recorded using a plurality of code lengths with the use of a Partial Response Maximum Likelihood (PRML) technique, the method comprising:
(a) converting a reproduction signal of the optical disc into a multi-value digital signal;
(b) performing waveform equalization on the multi-value digital signal on the basis of a predetermined partial response to generate an equalized reproduction signal;
(c) generating decoded data corresponding to data recorded on the optical disc from the equalized reproduction signal; and
(d) extracting a crest value for each of the code lengths on the basis of the decoded data and a type of the predetermined partial response.

8. The optical disc reproduction method of claim 7, wherein (d) further comprises identifying a code length from the decoded data and extracting an amplitude value of the equalized reproduction signal at a sampling point corresponding to a center of the identified code length as a crest value of the code length.

9. The optical disc reproduction method of claim 8, wherein (d) further comprises determining whether the number of the sampling points corresponding to the center is 1 or 2 on the basis of the identified code length and the type of the predetermined partial response, and in the case of two sampling points, extracting an average value of two amplitude values of the equalized reproduction signal corresponding to the two sampling points as the crest value of the code length.

10. The optical disc reproduction method of claim 9, wherein (d) further comprises determining that the number of the sampling points corresponding to the center is one in a case where the identified code length is an even number and also the response length of the predetermined partial response is an even number, or, in a case where the identified code length is an odd number and also the response length of the predetermined partial response is an odd number, and
determining that the number of the sampling points corresponding to the center is two in a case where the identified code length is an odd number while the response length of the predetermined partial response is an even number, or, in a case where the identified code length is an even number while the response length of the predetermined partial response is an odd number.
